(19) United States
(12) Patent Application Publication
(10) Pub. No.: US 2022/0161690 A1
(43) Pub. Date: May 26, 2022

(54) GLIDING DEVICE FOR A VEHICLE SEAT

(71) Applicant: Faurecia Sièges d'Automobile, Nanterre (FR)

(72) Inventors: David MOUSSET, Caligny (FR); Audrey DECAUX, Caligny (FR); Florent BAYART, Caligny (FR); Jérôme LE TUTOUR, Caligny (FR)

(21) Appl. No.: 17/535,907

(22) Filed: Nov. 26, 2021

(30) Foreign Application Priority Data
Nov. 26, 2020 (FR) FR 20 12189

(51) Int. Cl. B60N 2/015; B60N 2/07

(52) U.S. Cl. CPC B60N 2/015; B60N 2/07

(57) ABSTRACT

A gliding device includes a fixed part having at least one first profile, a support for attaching the gliding device to the floor of the vehicle, the first profile being attached to the support by at least one weld to form the fixed part. The gliding device further includes at least one reinforcing plate attached to the fixed part by the weld, the weld extending through the reinforcing plate and the first profile and into a portion of the support.

### TECHNICAL FIELD

The present invention relates to a gliding device for a vehicle seat of the type comprising a fixed part comprising at least a first profile, a frame for attaching the gliding device to the floor of the vehicle, the first profile being attached to the frame by at least one weld to form the fixed part.

The invention also relates to a vehicle comprising such a gliding device.

### BACKGROUND

In a vehicle, such as a motor vehicle, it is known to mount the vehicle seats on the floor of the vehicle by means of gliding devices for adjusting the position of the seat in the passenger compartment of the vehicle, in particular the position according to the fore-and-aft direction of the vehicle.

Each gliding device generally comprises a first profile, called female profile, attached on the floor of the vehicle and a second profile, called male profile, on which the seat is attached and mounted in a gliding manner on the first profile. In order to attach the first profile to the floor, a support is used which is attached to the floor and to which the first profile is for example welded.

However, in the event of an impact on the vehicle, particularly during an accident, the stresses on the seat can cause the weld between the first profile and the support to break and thus cause the seat to become detached from the vehicle floor. Such a separation is dangerous for the occupant of the seat and for the other passengers in the vehicle.

### SUMMARY

One of the objectives of the invention is to address this drawback by proposing a gliding device in which the attachment of the first profile to the support is robust and reduces, or even eliminates, the risks of the seat becoming detached in the event of an impact on the vehicle.

To this end, the invention relates to a seat gliding device of the aforementioned type, comprising at least one reinforcing plate attached to the fixed part by welding, the said welding extending through the said reinforcing plate and the said first profile and into a portion of the frame.

The reinforcing plate increases the thickness of the weld and improves its robustness because the weld passes entirely through the reinforcing plate and the first profile. Thus, the risks of the weld breaking in case of impact on the vehicle are reduced and the attaching of the seat to the floor is improved, thus limiting the risk of the seat becoming detached from the vehicle floor.

The invention may further present the following features, taken alone or in any technically conceivable combination:
the first profile comprises a base extending at least in part on the support and two arms extending on either side of and projecting from the base, the base being attached to the support by welding;
the reinforcing plate is attached to the base, the weld extending through the reinforcing plate and the support;
the reinforcing plate is attached to the base between the arms of the first profile, the base of the first profile extending between the reinforcing plate and the support;
the weld extends along a weld line on the reinforcing plate, the said weld line extending along at least one portion of the periphery of the reinforcing plate;
the first profile, the support and the reinforcing plate each comprise at least one through-hole, the through-holes of the said first profile, said support and said reinforcing plate extending opposite each other, the weld line extending around at least one portion of said through-holes
the weld is obtained by laser welding;
the weld presents a truncated cone-shaped cross-section, the width of the said weld decreasing from the reinforcing plate to the support;
the gliding device further comprises a second profile forming a movable part of the seat gliding device, the said second profile being slidably mounted on the first profile; and
the weld extends over a thickness of between 0.5 mm and 1.5 mm of the support, preferably between 0.5 mm and 1 mm, more preferably between 0.5 mm and 0.8 mm.

According to another aspect, the invention also relates to a vehicle comprising at least one seat, a gliding device as described above and a floor, the seat being mounted on the said floor via the gliding device, the support of the said gliding device being attached to the said floor.

### BRIEF DESCRIPTION OF THE DRAWINGS

Other aspects and advantages of the invention will become apparent from the following description, given by way of example and made with reference to the appended drawings, in which:

FIG. 1 is a schematic exploded perspective representation of a part of a seat gliding device according to an embodiment of the invention,

FIG. 2 is a schematic perspective representation of the gliding device part of FIG. 1, with the reinforcing plate attached to the fixed part of the gliding device, and

FIG. 3 is a schematic cross-sectional representation according to the axis III-III of FIG. 2.

### DETAILED DESCRIPTION

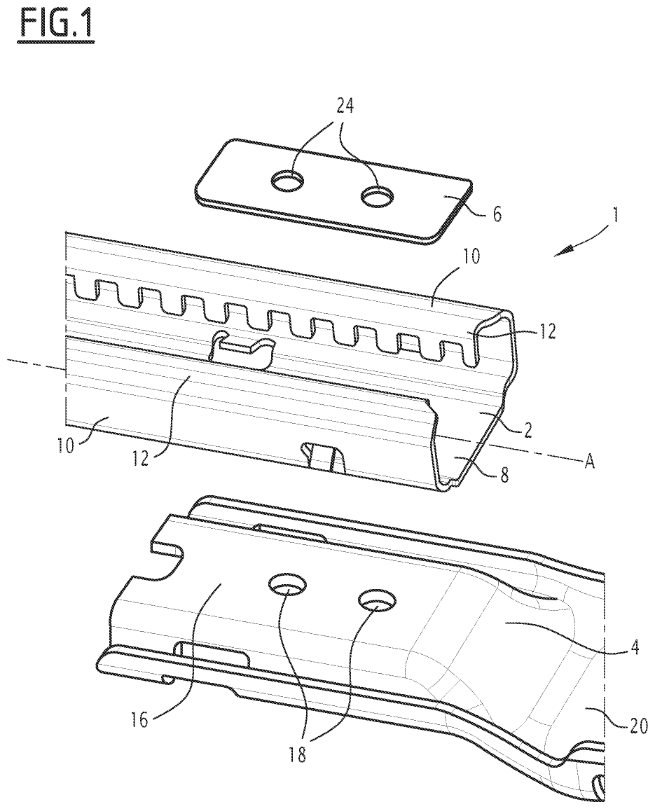

With reference to FIG. 1, a seat gliding device 1 is described comprising at least a first profile 2, a support 4 and a reinforcing plate 6.

The first profile 2 and the support 4 form a fixed part of the gliding device intended to be attached to the floor of a vehicle and cooperating with a movable part of the gliding device formed, for example, by a second profile (not shown) slidably mounted on the first profile 2.

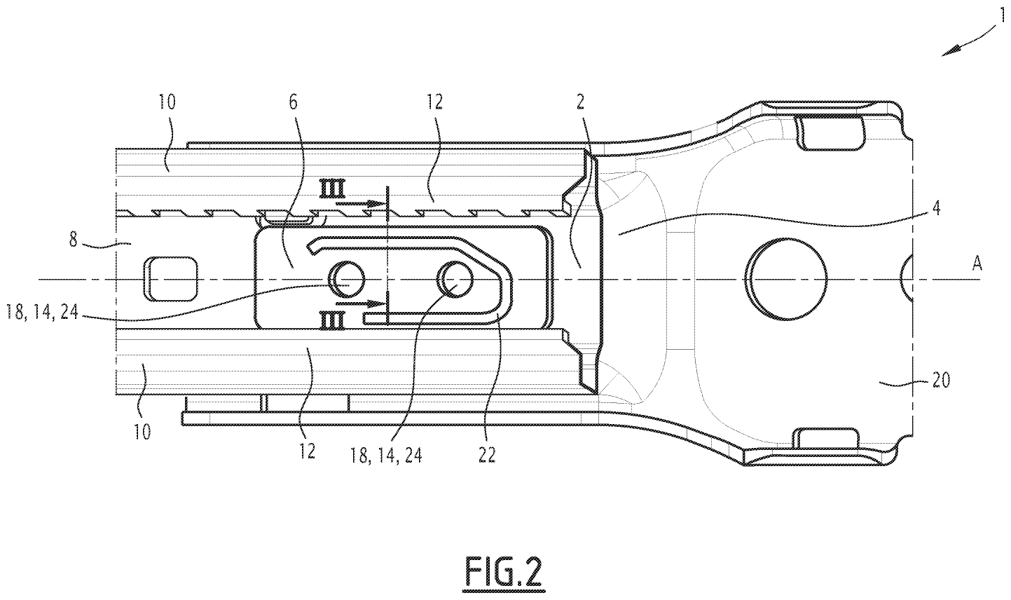

The first profile 2 is for example a female profile cooperating with the second profile which is a male profile slidably mounted on the female profile. The first profile 2 thus extends mainly according to a longitudinal direction A corresponding to the gliding direction of the second profile. The first profile 2 presents, for example, a substantially U-shaped cross section in a plane perpendicular to the longitudinal direction A. Thus, the first profile 2 comprises a base 8 and two arms 10 extending on either side of and projecting from the base 8. The arms 10 may have any shape suitable for forming a guide rail slidably receiving the second profile. Thus, according to the embodiment shown in FIGS. 1 and 2, the arms 10 each present, at their end opposite the base, a shoulder 12 forming a groove turned and open towards the base 8 and capable of slidingly receiving a corresponding part of the second profile.

The base 8 presents for example a thickness substantially equal to 1.5 mm. The base 8 comprises for example at least one through-hole 14 extending in the thickness of the base 8 and allowing the passage of an element for attaching to the floor, such as a screw. According to the embodiment shown in FIGS. 1 and 2, the first profile comprises two through-holes 14 extending in the vicinity of one longitudinal end of the first profile 2. It is understood that the through-holes 14 are, for example, also provided at the other longitudinal end of the first profile 2 in order to ensure a fastening of the first profile 2 to the floor over its entire length. Other through-holes may be provided between the longitudinal ends to ensure better attachment to the floor.

The second profile is, for example, attached to a seat of the vehicle so that the position of the seat can be adjusted along the longitudinal direction by moving the second profile within the first profile 2.

The support 4 forms an attachment interface between the first profile 2 and the vehicle floor. For this purpose, the support 4 is for example arranged to receive a portion of the first profile 2, for example one of its longitudinal end portions as shown in FIGS. 1 and 2 and to be secured to the floor by one or more fastening elements, such as screws. For this purpose, the support 4 comprises a fastening surface 16 receiving the base 8 of the first profile. The fastening surface 16 comprises, for example, one or more through-holes 18 extending through the thickness of the fastening surface 16, these through-holes 18 corresponding to the through-holes 14 of the base 8 and extending opposite thereto as shown in FIG. 2. In other words, the fastening surface 16 comprises as many through-holesl8 as there are in the part of the first profile 2 that is received on the fastening surface 16. Thus, in order to secure the support 4 and the first profile 2 to the vehicle floor, fastening elements, such as screws, are passed through the through-holes 14 and 18 and secured in the floor, for example by screwing. The support 4 presents, for example, a thickness substantially equal to 2.5 mm at the fastening surface 16.

The support 4 can also form one or more other attachment interfaces to other elements of the vehicle passenger compartment, such as an underfloor crossbar or other. For this purpose, the support 4 has, for example, a second attachment surface 20 shaped to match the element to which the support 4 is to be attached.

The gliding device may comprise several supports 4 for attaching different parts of the second profile 2 to the vehicle floor. Thus the gliding device comprises, for example two supports 4, each receiving a longitudinal end portion of the first profile 2. Alternatively, one support 4 may be provided extending along the entire length of the first profile 2. The remainder of the description will now detail the attachment between the second profile 2 and the support 4. It is understood that this description applies to the attachment between all supports 4 and the second profile.

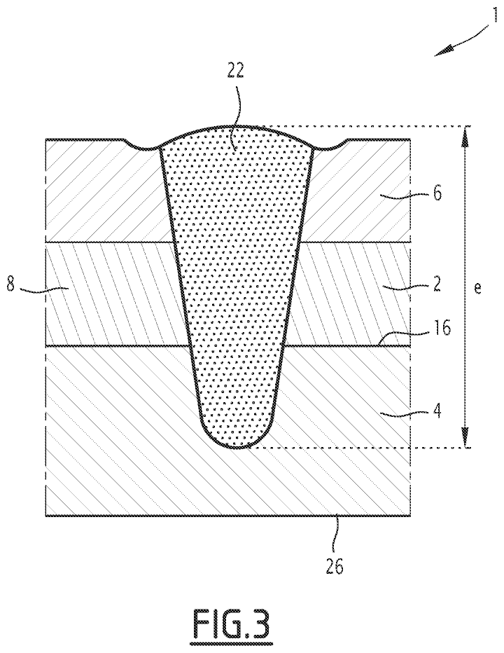

The first profile 2 is attached to the support 4 by at least one weld 22 passing through the thickness of a portion of the first profile 2 and extending into the thickness of a portion of the support 4, as shown in FIG. 3.

However, since such a weld 22 is not sufficient to prevent detachment between the first profile 2 and the support 4, in particular when a high load is applied to the seat, for example in the case of an impact on the vehicle, the gliding device 1 additionally comprises the reinforcing plate 6 which makes it possible to make the weld 22 more robust, as will now be described.

The reinforcing plate 6 is applied to the fixed part in order to locally increase its thickness in the attachment area in which the weld 22 extends. The thickness is measured in a direction perpendicular to the longitudinal direction A corresponding to the stacking direction of the support 4, the first profile 2 and the reinforcing plate 6.

The reinforcing plate 6 is, for example, attached to the base 8 of the first profile 2 between the arms 10 so that the base 8 extends between the fastening surface 16 of the support 4 and the reinforcing plate 6, as more particularly visible in FIG. 3. Alternatively, the reinforcing plate 6 could be interposed between the base 8 of the first profile 2 and the fastening surface 16 of the support 4.

As previously indicated, the reinforcing plate 6 is attached locally to the fixed part, i.e. its dimensions, in particular along the longitudinal direction, are reduced compared to those of the base 8 of the first profile 2. Thus, according to the embodiment shown in FIGS. 1 and 2, the reinforcing plate 6 presents a length, measured according to the longitudinal direction, corresponding substantially to the length over which the base 8 is attached to the receiving surface 16 of the support 4. The thickness of the reinforcing plate 6 is, for example, of the same order of magnitude as that of the base 8 of the first profile 2. Thus, the thickness of the reinforcing plate 6 is, for example, substantially equal to 1.5 mm.

When the reinforcing plate 6 is to be attached in a fastening area in which the first profile 2 and the support 4 comprise through-holes 14, 18, the reinforcing plate 6 also comprises one or more corresponding through-holes 24 extending into the thickness of the reinforcing plate 6. When the reinforcing plate 6 is attached to the fixed part, the one or more through-holes 24 extend opposite the through-holes 14, 18 of the first profile 2 and of the support 4 in order to allow the passage of fastening elements through the reinforcing plate 6, the first profile 2 and the support 4 to the floor of the vehicle through these through-holes 14, 18, 24.

The reinforcing plate 6 is, for example, a metal plate, for example made of steel or the like. According to one embodiment, the reinforcing plate 6 is made of the same material as the first profile 2.

The weld 22 also extends through the thickness of the reinforcing plate 6. In other words, the weld 22 extends, as shown in FIG. 3, through the thickness of the reinforcing plate 6, through the thickness of the base 8 of the first profile 2, and penetrates a portion of the thickness of the support 4. Thus, the weld 22 extends from the outer side of the gliding device facing the vehicle passenger compartment into the interior of the support 4, thereby securing the support plate 6 to the base 8 of the first profile 2 and securing the base 8 of the first profile 2 to the attachment surface 16 of the support 4.

The weld 22 extends, for example, over a depth of between 0.5 mm and 1.5 mm of the support 4, preferably between 0.5 mm and 1 mm, and more preferably between 0.5 mm and 0.8 mm. Thus, the thickness e, or depth as shown in FIG. 3, of the weld 22 is for example between 3.5 mm and 4.5 mm, preferably between 3.5 mm and 4 mm, and even more preferably between 3.5 mm and 3.8 mm. Thus, as previously indicated, the depth of the weld 22 is increased by a value substantially equal to the thickness of the reinforcing plate 6, which improves its robustness and makes it possible to limit the risks of tearing between the first profile 2 and the support 4, particularly in the event of an impact on the vehicle.

In section in a plane substantially perpendicular to the longitudinal direction A, the weld 22 presents, for example, a substantially truncated conical shape, the width of the weld 22 decreasing from the reinforcing plate 6 to the support 4, as shown in FIG. 3. The width is measured along a direction substantially perpendicular to the longitudinal direction A and to the depth e of the weld 22. Thus, as the weld 22 penetrates into the gliding devicel, the width of the weld 2 decreases.

As shown in FIG. 2, the weld 22 extends, for example according to a weld line on the reinforcing plate 6. The weld line extends, for example, along at least one portion of the periphery of the reinforcing plate 6. Thus, in the case of a substantially rectangular reinforcing plate 6 as shown in FIG. 2, the weld line extends, for example, along at least one edge of the reinforcing plate extending according to the length of the rectangle and, for example, along an adjacent edge extending according to the width of the rectangle. Between the length and width, the weld line may present an inclined section. According to the embodiment shown in FIG. 2, the weld line further comprises a section extending along a portion of the other edge extending according to the length of the rectangle. Thus, according to the embodiment shown in FIG. 2, the weld line extends around the through-holes 14, 18, 24. It is understood that other forms of weld lines can be considered, for example a weld line extending along the entire periphery of the reinforcing plate 6. According to the embodiment shown in FIG. 2, the weld line is continuous. It is understood, however, that the weld line could be interrupted and comprise several distinct sections spaced apart from each other. Alternatively, the weld 22 does not extend according to a weld line but is punctual, several weld points 22 being distributed over the reinforcing plate 6, for example.

The weld 22 is for example obtained by laser welding by subjecting the gliding device 1 to laser radiation causing the materials constituting the reinforcing plate 6, the first profile 2 and the support 4 to melt and mix. Alternatively, the welding can be achieved by MAG (Metal Active Gas) arc welding.

The above-described gliding device 1 provides a robust fixed part with a greatly reduced risk of the first profile 2 and the support 4 being torn off, particularly in the event of an impact on the vehicle. Thus, the risks of the seat becoming detached from the vehicle floor in the event of an accident are reduced.

1. A gliding device for a vehicle seat comprising a fixed part comprising at least a first profile, a support intended to attach the gliding device to the floor of the vehicle, the first profile being attached to the support by at least one weld to form the fixed part, wherein the gliding device further comprises at least one reinforcing plate attached to the fixed part by the weld, the said weld extending through said reinforcing plate and said first profile and into a portion of the support.

2. The gliding device according to claim 1, wherein the first profile comprises a base extending at least in part over the support and two arms extending on either side of and projecting from the base, the base being secured to the support by the weld.

3. The gliding device according to claim 2, wherein the reinforcing plate is attached to the base, the weld extending through the reinforcing plate and the base.

4. The gliding device according to claim 3, wherein the reinforcing plate is attached to the base between the arms of the first profile, the base of the first profile extending between the reinforcing plate and the support.

5. The gliding device according to claim 1, wherein the weld extends according to a weld line on the reinforcing plate, the said weld line extending along at least one portion of the periphery of the reinforcing plate.

6. The gliding device according to claim 5, wherein the first profile, the support, and the reinforcing plate each comprising at least one through-hole, the through-holes of the said first profile, the said support, and the said reinforcing plate extending opposite one another, the weld line extending around at least one portion of the said through-holes.

7. The gliding device according to claim 1, wherein the weld is obtained by laser welding.

8. The gliding device according to claim 1, wherein the weld presents a truncated cone-shaped cross-section, the width of the said weld decreasing from the reinforcing plate to the support.

9. The gliding device according to claim 1, further comprising a second profile forming a movable part of the seat gliding device, the said second profile being slidably mounted on the first profile.

10. The gliding device according to claim 1, wherein the weld extends over a thickness between 0.5 mm and 1.5 mm of the support, preferably between 0.5 mm and 1 mm, more preferably between 0.5 mm and 0.8 mm.

11. A vehicle comprising at least one seat, the gliding device according to claim 1 and a floor, the seat being mounted on the said floor via the gliding device, the support of the said gliding device being attached to the said floor.
